(19) United States
(12) Patent Application Publication
(10) Pub. No.: US 2020/0242600 A1
(43) Pub. Date: Jul. 30, 2020

(54) SYSTEM FOR LEVERAGED COLLABORATIVE PRE-VERIFICATION AND AUTHENTICATION FOR SECURE REAL-TIME RESOURCE DISTRIBUTION

(71) Applicant: Bank of America Corporation, Charlotte, NC (US)

(72) Inventors: Rosemary Carbery Stack, Wilmington, DE (US); Richard C. Clow, II, Morristown, NJ (US); Joseph Benjamin Castinado, North Glenn, CO (US)

(73) Assignee: Bank of America Corporation, Charlotte, NC (US)

(21) Appl. No.: 16/262,446

(22) Filed: Jan. 30, 2019

(51) Int. Cl. G06Q 20/40; H04W 12/06; H04L 29/06; G06Q 20/02

(52) U.S. Cl. CPC G06Q 20/40; G06Q 20/023; H04L 63/126; H04W 12/0602

(57) ABSTRACT

Embodiments of the present invention provide a system for providing leveraged collaborative pre-verification and authentication for secure real-time resource distribution associated with a managing entity. Within a real-time resource distribution processing network, when a resource distribution request is received, historical verification factors are identified and used to establish a statistical model of how an associated account is expected to operate. Features of the pending resource distribution request are analyzed with respect to the statistical model to establish a pre-verification value of the user. Based on this established pre-verification value, the resource distribution request can be pre-verified or terminated, or additional authentication credentials can be prompted and received from a computing device of a user associated with the resource distribution request to verify the resource distribution request in real-time.

### BACKGROUND

Resource distribution requests, and subsequent analysis and execution, typically require timely communication between multiple systems and entities, and therefore have not included significant amounts of verification information in the requests or analysis. By implementing an interactive real-time resource processing network that facilitates the transfer of messages and additional data and information along with the required distribution request information, real-time pre-verification analysis can occur for requested resource distributions without unnecessary and timely intermediary steps that would otherwise delay the request from being executed.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for providing leveraged collaborative pre-verification and authentication for secure real-time resource distribution associated with a managing entity. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve receiving, from a first entity system, a message from a user comprising at least a resource distribution request from a first account that is external to the managing entity to a second account that is internal to the managing entity. The system may then extract verification factors from the message associated with the first account or the user, and determine a verification value for the user based on the extracted verification factors. The system can then determine whether the verification value for the user is above a predetermined threshold value. In response to determining that the verification value for the user is above the predetermined threshold value, the system may automatically verify the user for the resource distribution request. Alternatively, in response to determining that the verification value for the user is not above the predetermined threshold value, the system may automatically terminate the resource distribution request.

In embodiments of the system where the message comprises the verification factors, the step of extracting the verification factors from the message comprises extracting the verification factors information directly from the message.

The message of the system may comprise a reference number associated with the verification factors. In such embodiments, the step of extracting the verification factors comprises extracting the reference number from the message, transmitting the reference number and a request for the verification factors to the first entity system, and receiving the verification factors from the first entity system. Alternatively, the step of extracting the verification factors may comprise extracting the reference number from the message, transmitting the reference number and a request for the verification factor to a clearing house database system, and receiving the verification factors from the clearing house database system.

In some embodiments of the system, the message comprises a clearing house database index position associated with the verification factors. In such embodiments, the step of extracting the verification factors comprises extracting the clearing house database index position associated with the verification factors, and identifying the verification factors in the clearing house database at the clearing house database index position.

The verification factors described herein may comprise one or more of a group of: a last time the first account was utilized in a transaction, a frequency of transaction utilization for the first account, a most frequent period of time during a day for the first account to be accessed or utilized, a most frequent period of time during a month when transactions of a particular category are made with the first account, a length of time that the first account has been open or active, a range of most common resource amounts associated with resource distributions from the first account, a set of most common product categories associated with the first account in an amount range associated with the resource distribution request, a set of most common merchants or merchant types associated with resource distributions from the first account, most commonly used transaction devices or transaction device types associated with resource distributions from the first account, a geographic area from which resource distributions from the first account are most commonly requested, additional account information associated with accounts of the user that are external to the managing entity and distinct from the first account, and a total number or frequency of requests to restore resources from previous resource distribution requests from the first account.

In some embodiments of the system, the step of determining whether the verification for the user is above the predetermined threshold value comprises determining that the verification value for the user is not above the predetermined threshold value and determining that the verification value for the user would be above the predetermined threshold if the user provided stepped-up authentication credentials. In response to determining that the verification value for the user is not above the predetermined threshold, and in response to determining that the verification value for the user would be above the predetermined threshold if the user provided stepped-up authentication credentials, the system may automatically transmit a request for a user input of the stepped-up authentication credentials to a computing device associated with the user in real-time. The system may then determine that the verification value for the user is not above the predetermined threshold value in response to not receiving the user input of the stepped-up authentication credentials. Alternatively, the system may determine that the verification value for the user is above the predetermined threshold value in response to receiving the user input of the stepped-up authentication credentials via the computing device associated with the user.

In some embodiments, the system may further determine that the verification value for the user is above the predetermined threshold value, but not above a secondary predetermined threshold value. In response to determining that the verification value for the user is not above the secondary predetermined threshold value, the system may transmit a notification to a computing device associated with the user, wherein the notification comprises a request for a user input of (i) a confirmation that the resource distribution request is intended, and (ii) an agreement that a resource recovery amount for the resource distribution request is limited to a first amount. In such embodiments, the step of automatically verifying the user for the resource distribution request is additionally conducted in response to receiving the user input of (i) the confirmation that the resource distribution request is intended, and (ii) the agreement that the resource recovery amount for the resource distribution request is limited to the first amount.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A illustrates a diagram illustrating a system environment for providing real-time resource distribution using a clearing house, in accordance with an embodiment of the invention.

FIG. 1B provides a block diagram illustrating a system environment for providing leveraged collaborative pre-verification and authentication for secure real-time resource distribution associated with a managing entity, in accordance with embodiments of the invention, in accordance with embodiments of the invention;

FIG. 2 provides a block diagram illustrating the managing entity system of FIG. 1B, in accordance with an embodiment of the invention;

FIG. 3 provides a block diagram illustrating the clearing house system of FIG. 1B, in accordance with an embodiment of the invention;

FIG. 4 provides a block diagram illustrating the computing device system of FIG. 1B, in accordance with an embodiment of the invention; and

FIG. 5 provides a flowchart illustrating a process for providing leveraged collaborative pre-verification and authentication for secure real-time resource distribution associated with a managing entity, in accordance with embodiments of the invention, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Embodiments of the present invention provide a system and method for providing leveraged collaborative pre-verification and authentication for secure real-time resource distribution associated with a managing entity. In general, the described system and method provide a technique for matching (e.g., based on a determined confidence level) an external account being used in a requested resource distribution request with the purported user in real-time (before the resource distribution has been executed, and while the purported user is still performing the distribution request steps or is still within a resource distribution application), via a real-time resource processing network.

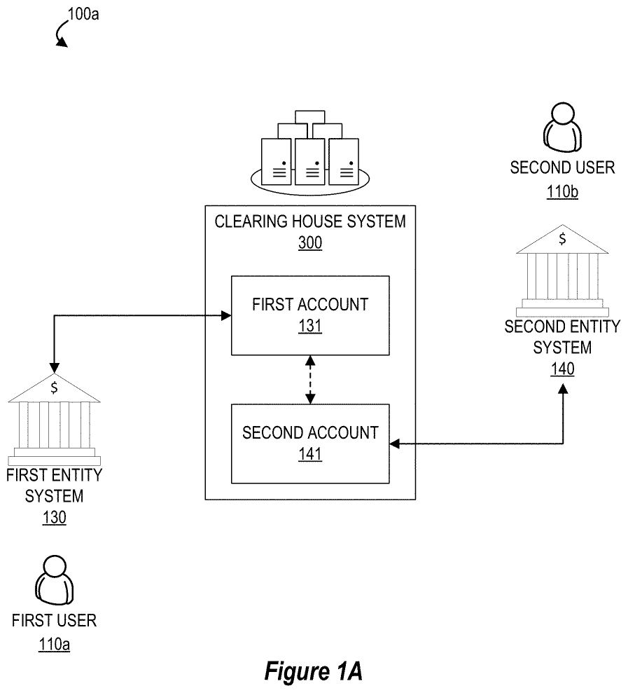

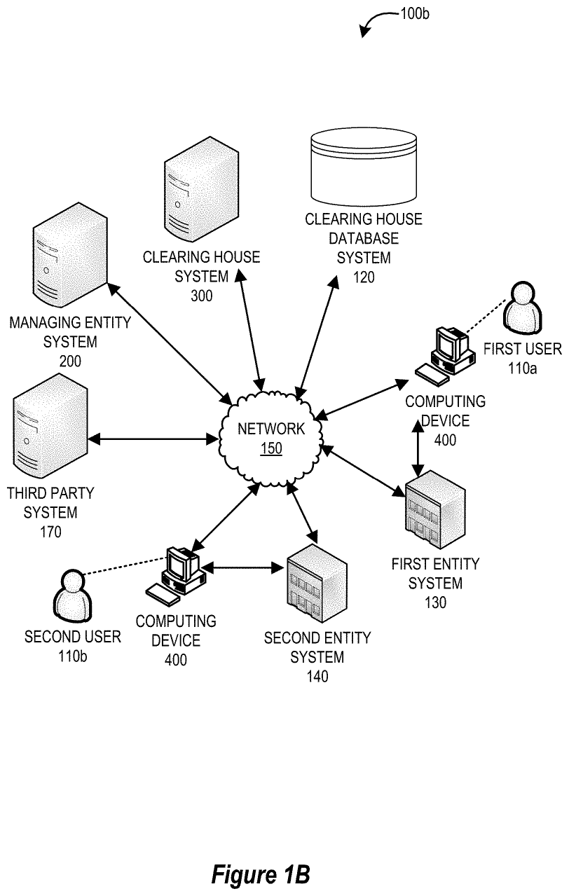

FIG. 1A illustrates a block diagram of a high-level real-time interaction flow system environment 100a, in accordance with one embodiment of the invention. In the illustrated environment, a first user 110a is associated with (i.e., is a customer of) a first entity system 130 and a second user 110b is associated with a second entity system 140. A clearing house system 300 comprises a first entity account 131 associated with the first entity system 130 and a second entity account 141 associated with the second entity system 140. The first entity account 131 and the second entity account 141 are accessible by each associated financial institution and the clearing house system 300 which acts as a trusted intermediary during settlement between the financial institutions. Resources or funds may be transferred or otherwise distributed by each financial institution to and from their associated account. Transfers between the first entity account 131 and the second entity account 141 are administered by the clearing house system 300 pending authentication and authorization by participating parties of each transfer.

In one embodiment, the first user 110a and the second user 110b are participants of a real-time interaction system, wherein the first user 110a (i.e., the payor) initiates a credit transfer to the second user 110b (i.e., the payee). In a specific example, the first user 110a is required to initiate the transfer from the first entity system 130, wherein the first user 110a provides authentication information to authenticate the identity of the first user 110a and to validate that an account of the first user 110a held at the first entity system 130 contains at least a sufficient amount of available funds to fulfill the transfer. While in one embodiment, the first user 110a is required to initiate the transfer from a physical, brick-and-mortar location of the first entity system 130, in alternative embodiments described herein, the transfer may be initiated from other locations wherein a user is not required to be at a brick-and-mortar location (e.g., via an electronic application of a computing device, A mobile device application, a website, or the like).

The first user 110a, as the sending participant (i.e., payor), is required to authenticate his or her identity by providing information or credentials to the associated financial institution. For example, authentication information may include account numbers, routing numbers, PIN numbers, username and password, date of birth, social security number, or the like, or other authentication information as described herein. In some embodiments, authentication may comprise multi-factor or multi-step authentication in accordance with information security standards and requirements.

Upon initiating an interaction, the first user 110a becomes obligated to pay the amount of the interaction, wherein the interaction cannot be canceled by the first user 110a following initiation and transmission of communication (e.g., a message) to a receiving participant. Communication between the first entity system 130 and the second entity system 140 may be conducted via the clearing house system 300 which directs the payment to the appropriate financial institution associated with the receiving participant. The transfer of funds occurs between the first entity account 131 and second entity account 141 associated with the first entity system 130 and the second entity system 140 on behalf of their associated users, wherein the interaction may be settled immediately, concurrent with the interaction. As settlement occurs between the representative financial institutions, debiting and crediting of individual user accounts may be managed at each financial institution with their associated customers. As the interaction may be settled in real time (pending verification of the first user 110a as the owner of the first account 131, as described in detail herein), funds may be made available for use in real or near real-time.

It should be understood that while the illustrated embodiment of FIG. 1A depicts only first and second users, financial institutions, and accounts, other embodiments of a real-time interaction network may comprise a plurality of accounts associated with a plurality financial institutions. In some embodiments, the system environment 100a may further comprise more than one clearing house system 300 (e.g., TCH, the Federal Reserve, and the like) that receive and process interaction requests as described herein. Financial institutions may include one or more community banks, regional banks, credit unions, corporate banks, direct connect financial institutions, and the like.

In accordance with embodiments of the invention, the terms “entity system” may include any organization such as one that processes financial transactions including, but not limited to, financial institutions, banks, credit unions, savings and loan associations, card associations, settlement associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution or a potential customer of the entity (e.g., a financial institution) or an employee of the entity.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, personal computing devices, tablet computers, wearable devices, smart devices, portable electronic devices, wearable devices, automated teller machines (ATMs), electronic kiosks, or other electronic devices capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

FIG. 1B provides a block diagram illustrating a system environment 100b for a real-time resource processing network, in accordance with an embodiment of the invention. As illustrated in FIG. 1B, the environment 100 includes a managing entity system 200, a clearing house system 300, a clearing house database system 120, a first entity system 130, a second entity system 140, one or more computing device systems 400, and one or more third party systems 160.

One or more users, including a first user 110a and a second user 110b, may be in network communication with the first entity system 130, the second entity system 140, or the other systems of the system environment 100b via a computing device system 400. These users 110a and 110b may be customers, clients, patrons, or the like of one or more entities associated with the first entity system 130 and/or the second entity system 140.

The managing entity system 200, the clearing house system 300, the clearing house database system 120, the first entity system 130, the second entity system 140, the one or more computing device systems 400, and the one or more third party systems 160 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

The managing entity system 200 may be a system owned or otherwise controlled by a managing entity to perform one or more process steps described herein. In some embodiments, the managing entity is a financial institution, a clearing house entity, a consortium of financial institutions and/or clearing house entities, or the like. While the managing entity system 200 is shown as a separate entity from other systems in the system environment 100b, it should be known that the managing entity may comprise one or more of the other systems in the system environment 100b.

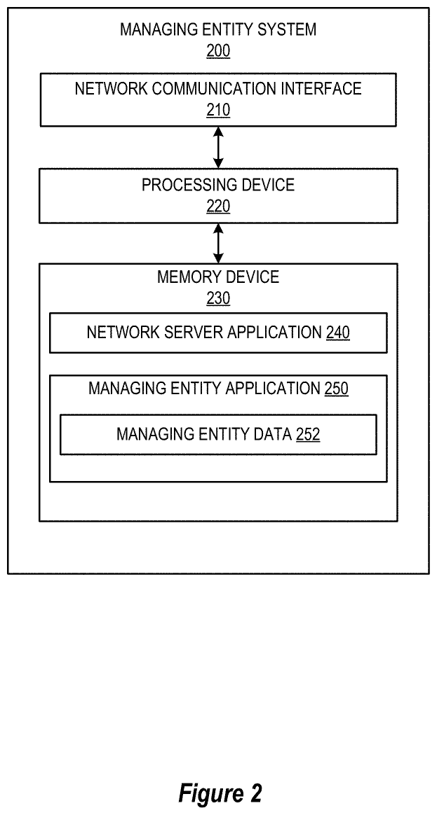

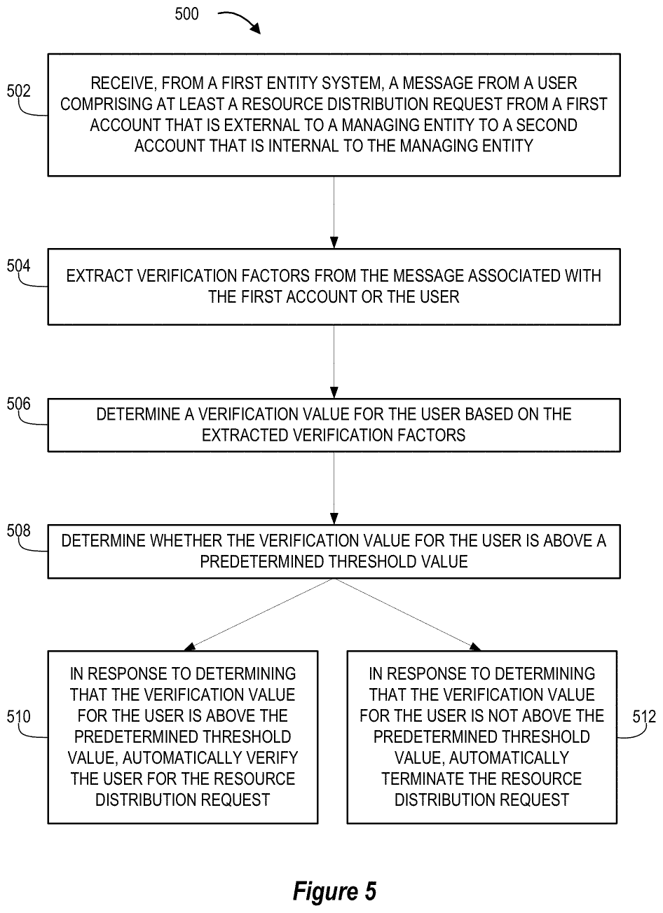

In general, the managing entity system 200 is configured to communicate information or instructions with the clearing house system 300, the clearing house database system 120, the first entity system 130, the second entity system 140, the one or more computing device systems 400, and/or one or more third party systems 160 across the network 150. For example, the managing entity system 200 may be a component of, or have control over the second entity system 140 and/or the clearing house system 300 and perform the process steps of process 500, as described with respect to FIG. 5. Of course, the managing entity system 200 may be configured to perform (or instruct other systems to perform) one or more other process steps described herein. The managing entity system 200 is described in more detail with respect to FIG. 2.

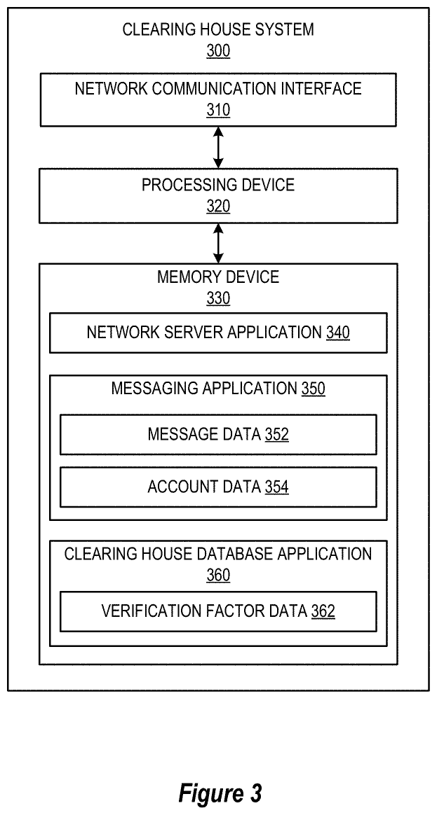

As noted above with respect to FIG. 1A, the clearing house system 300 may be a system owned or controlled by the managing entity, a consortium of entities (e.g., the first entity, the second entity, the managing entity, and the like) and/or a third party that specializes in maintaining financial accounts, performing financial transaction clearing house functions, generating and/or transmitting financial transaction messages, and the like. In general, the clearing house system 300 is configured to communicate information or instructions with the managing entity system 200, the clearing house database system 120, the first entity system 130, the second entity system 140, the one or more computing device systems 400, and/or the third party system 160 across the network 150. For example, the clearing house system 300 may be configured to receive a message from a computing device system 400 associated with the first user 110a and/or the first entity system 130, perform a pre-verification of the first user 110a with respect to a transferring account of the first user 110a and the first entity system 130, transfer (or prevent the transfer of) a resource distribution amount from an account of the first entity system 130 to an account of the second entity system 140, and/or extract and transmit verification factors information stored in the clearing house database system 120. Of course, the clearing house system 300 may be configured to perform (or instruct other systems to perform) one or more other process steps described herein. The clearing house system 300 is described in more detail with respect to FIG. 3.

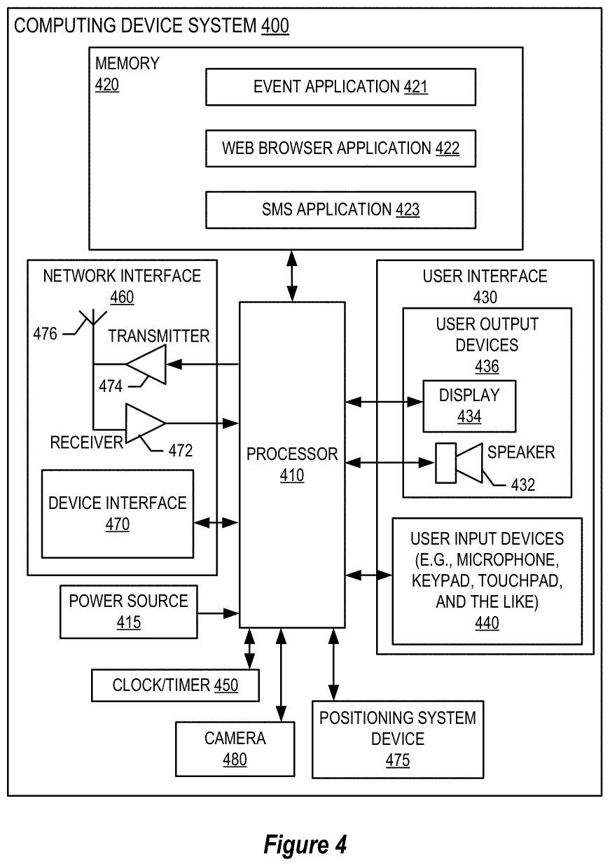

The one or more computing device system(s) 400 may be a system owned or controlled by the managing entity, and/or a third party that specializes in providing computing devices and/or mobile computing devices to users (e.g., user 110a and user 110b). In general, a computing device system 400 is configured to provide a communication and/or transaction interface for the first user 110a or the second user 110b to provide instructions to, or receive notifications from, the managing entity system 200, the clearing house system 300, the clearing house database system 120, the first entity system 130, the second entity system 140, and/or the third party system 160 across the network 150. For example, the computing device system 400 associated with the first user 110a may be configured to receive a resource distribution request from the first user 110a, generate a message based on the resource distribution request (e.g., via a resource distribution or transaction application stored in the memory of the computing device system 400), and transmit the message and/or resource distribution request (or a combination of the two as one resource distribution request) to the first entity system 130. Of course, the computing device system 400 may be configured to perform (or instruct other systems to perform) one or more other process steps described herein. A sample computing device system 400 is described in more detail with respect to FIG. 4.

The clearing house database system 120 may comprise a network communication interface, a processing device, and one or more memory devices, where the processing devices are configured to perform certain actions with the memory devices and communicate these actions to the rest of the network 150 through its network communication interface. The clearing house database system 120 may be a repository for the clearing house system 300 to store verification factor information. In some embodiments, the clearing house database comprises a blockchain network that records verification factor information, where the verification factor information is accessible to any system or user with the appropriate public blockchain key.

The first entity system 130 may comprise a network communication interface, a processing device, and one or more memory devices, where the processing devices are configured to perform certain actions with the memory devices and communicate these actions to the rest of the network 150 through its network communication interface. In some embodiments, the first entity system 130 comprises a financial institution at which the first user 110a is a customer. The first entity system 130 may have one or more financial accounts that are available to, at least partially controlled by, or otherwise accessible by the clearing house system 300 such that the clearing house system 300 is pre-authorized to perform user pre-verification analysis and execute transactions with the account of the first entity system 130 upon receipt of messages from the first entity system 130, the second entity system 140, the first user 110a, and/or the second user 110b.

The second entity system 140 may comprise a network communication interface, a processing device, and one or more memory devices, where the processing devices are configured to perform certain actions with the memory devices and communicate these actions to the rest of the network 150 through its network communication interface. In some embodiments, the second entity system 140 comprises a financial institution at which the second user 110b is a customer. The second entity system 140 may have one or more financial accounts that are available to, at least partially controlled by, or otherwise accessible by the clearing house system 300 such that the clearing house system 300 is pre-authorized to perform user pre-verification analysis and execute transactions with the account of the second entity system 140 upon receipt of messages from the first entity system 130, the second entity system 140, the first user 110a, and/or the second user 110b. In some embodiments, the format of the communication complies with or is otherwise compatible with the ISO 20022 standard.

The third party system 160 may be any system that is in communication with the network 150 and executes one or more functions or process steps of the processes described herein (e.g., as a shared database system, as a verification factor data feed system, as a secure communication network infrastructure and system, and/or the like) with respect to the system environment 100b.

FIG. 2 provides a block diagram illustrating the managing entity system 200, in greater detail, in accordance with embodiments of the invention. As illustrated in FIG. 2, in one embodiment of the invention, the managing entity system 200 includes one or more processing devices 220 operatively coupled to a network communication interface 210 and a memory device 230. In certain embodiments, the managing entity system 200 is operated by a first entity, such as a financial institution, while in other embodiments, the managing entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the managing entity system 200 described herein. For example, in one embodiment of the managing entity system 200, the memory device 230 includes, but is not limited to, a network server application 240, a managing entity application 250 which includes managing entity data 252 and other computer-executable instructions or other data. The computer-executable program code of the network server application 240 and/or the managing entity application 250 may instruct the processing device 220 to perform certain logic, data-processing, and data-storing functions of the managing entity system 200 described herein, as well as communication functions of the managing entity system 200.

The managing entity application 250 may be configured to invoke or use the managing entity data 252 to perform one or more processes and functions of the other systems (i.e., the clearing house system 300, the clearing house database system 120, the first entity system 130, the second entity system 140, the third party system 160, and/or the one or more computing device systems 400) within the system environment 100b, as defined or described herein.

FIG. 3 provides a block diagram illustrating the clearing house system 300, in greater detail, in accordance with embodiments of the invention. In some embodiments, at least a component of the clearing house system 300 is comprised within, or comprises, the managing entity system 200. As illustrated in FIG. 3, in one embodiment of the invention, the clearing house system 300 includes one or more processing devices 320 operatively coupled to a network communication interface 310 and a memory device 330. In certain embodiments, the clearing house system 300 is operated by a first entity, such as a financial institution, while in other embodiments, the clearing house system 300 is operated by an entity other than a financial institution.

It should be understood that the memory device 330 may include one or more databases or other data structures/repositories. The memory device 330 also includes computer-executable program code that instructs the processing device 320 to operate the network communication interface 310 to perform certain communication functions of the clearing house system 300 described herein. For example, in one embodiment of the clearing house system 300, the memory device 330 includes, but is not limited to, a network server application 340, a messaging application 350 which includes message data 352 and account data 354, a clearing house database application 360 which includes verification factor data 362, and other computer-executable instructions or other data. The computer-executable program code of the network server application 340, the messaging application 350, and/or the clearing house database application 360 may instruct the processing device 320 to perform certain logic, data-processing, and data-storing functions of the clearing house system 300 described herein, as well as communication functions of the clearing house system 300.

In one embodiment, the messaging application 350 includes message data 352 and account data 354. The message data 352 may comprise instructions, terms, amounts, descriptions, content, and other information that is to be transferred from a first entity system to another entity system via a notification and/or as a transaction between accounts of each entity system. The account data may include account numbers, pre-authorization data, account limits or other threshold information, and the like that allows the clearing house system 300 to automatically transfer funds from a first entity system's account to a second entity system's accounts without additional approvals or confirmations from the entities, based on instructions provided to the clearing house system 300 via a received message.

In one embodiment, the clearing house database application 360 includes verification factor data 362. This verification factor data 362 may include text, documents, contracts, agreements, user generated or curated content, media, files, notifications, memorandum, notes, and other information that relate to the tendencies, trends, behavioral patterns, and the like of a user with respect to the user's interaction with and control over a particular account of the user. The verification factor data 362 may comprise resource distribution timing information, account time information, resource distribution amount information, account balance information, general transactional information, location information, transaction device information, account comparison information, account management or maintenance information, user claims information, and/or merchant claims information associated with individual accounts and/or associated with individual users with respect to one or more accounts of the users.

The clearing house database application 360 may be configured to access its database and identify verification factor data based on received inputs of reference numbers, passcodes, database index positions, public blockchain keys, and the like, as described herein.

The network server application 340 the messaging application 350, and the clearing house database application 360 are configured to invoke or use the message data 352, the account data 354, the verification factor data 362, and the like when communicating through the network communication interface 310 with the managing entity system 200, the clearing house database system 120, the one or more computing device systems 400, the first entity system 130, the second entity system 140, and/or the third party system 160.

FIG. 4 provides a block diagram illustrating an example computing device system 400 of FIG. 1B in more detail, in accordance with embodiments of the invention. In one embodiment of the invention, the computing device system 400 is a mobile telephone. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of a wireless network. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422 and/or a resource distribution application 421 (or any other application provided by the managing entity system 200 and/or the clearing house system 300). These applications also typically instructions to a graphical user interface (GUI) on the display 430 that allows the user 110 to interact with the computing device system 400, the managing entity system 200, and/or other devices or systems. In one embodiment of the invention, when the user (e.g., user 110a or user 110b) decides to enroll in a resource distribution application 421 program, the user downloads, is assigned, or otherwise obtains the resource distribution application 421 from the managing entity system 200, the clearing house system 300, the first entity system 130, the second entity system 140, or from a distinct application server. In other embodiments of the invention, the user 110 interacts with the managing entity system 200, the clearing house system 300, the clearing house database system 120, the first entity system 130, the second entity system 140, a third party system, or another computing device system 400 via the web browser application 422 in addition to, or instead of, the resource distribution application 421.

The resource distribution application 421 may be configured to transmit and receive messages, notifications, calls, electronic mail messages, and the like, between a user and an entity associated with the resource distribution request (e.g., a first entity system, a second entity system, and/or a clearing house system). In this way, the resource distribution application 421 acts as a communication interface that allows the user to perform any of the user-controlled or initiated actions described herein, including but not limited to transaction requests, resource distribution requests, and the like.

The memory 420 of the computing device system 400 may comprise a Short Message Service (SMS) application 423 configured to send, receive, and store data, information, communications, alerts, and the like via a wireless telephone network.

The memory 420 can also store any of a number of pieces of information, verification factors (e.g., transaction device data), and other data used by the computing device system 400 and the applications and devices that make up the computing device system 400 or are in communication with the computing device system 400 to implement the functions of the computing device system 400 and/or the other systems described herein.

Referring now to FIG. 5, a flowchart is provided to illustrate one embodiment of a process 500 for providing leveraged collaborative pre-verification and authentication for secure real-time resource distribution associated with a managing entity, in accordance with embodiments of the invention. In some embodiments, the process 500 may include block 502, where the system receives, from a first entity system, a message from a user comprising at least a resource distribution request from a first account that is external to a managing entity to a second account that is internal to the managing entity. In some embodiments, the message is received via a real-time resource processing network like the one described with respect to FIG. 1B.

As used herein, the term “verification factors” may include any information, data, relationships, models derived from data, trends, commonalities, or the like, that can be analyzed to determine whether an individual (i.e., the user) attempting to utilize a particular account is in fact the correct individual that is associated with that account. In some embodiments, the verification factors described herein do not include sensitive transaction data (e.g., specific transaction amounts, personally identifiable information, and the like), but instead comprise information that is not sensitive and/or is derived from the sensitive transaction data. Using non-sensitive verification factors is an important feature when the verification factors are communicated between different entities (e.g., financial institutions) because the transfer of non-sensitive information is a more secure process and more readily adheres to government rules and regulations on the communication of information than the transfer of sensitive information.

Although the specific sensitive account or transaction information for the user is not shared as part of the verification factors, the managing entity is still allowed visibility across the real time resource processing network by the first entity system to non-sensitive information that still provides value, especially when viewed in combination, in user pre-verification steps for resource distribution requests. In the past, entities involved in resource distribution processes, and financial institutions in particular, have not had visibility into the verification factors for accounts that are not held or managed with that entity. Additionally, historical resource distribution processes, including financial transactions, have not been able to transfer significant supplemental information along with a resource distribution request and instead only included basic information like account numbers, transaction amounts, payor and payee names, dates, routing numbers, and magnetic ink character recognition (MICR) values. However, the real time resource processing network described herein does allow for the transfer of additional significant information as part of a distribution request, which can comprise verification factors and/or indicia that are associated with the verification factors.

As such, the message may include or comprise verification factors or any form of indicia (e.g., reference code, database file path address, database index position information, or the like) that provide information about the verification factors or provide a pathway or technique for extracting the verification factors from a separate memory source. In this way, at least a portion of the verification factors does not need to be transmitted as part of the message, but instead can be identified and transmitted or accessed by the managing entity via a shared database, blockchain network, or the like. In embodiments where verification factor information is stored in a blockchain database, a public key associated with the verification factor information may be included in the message.

While verification factors are generally described as being information about the external account and/or user that is requesting a resource distribution to an account of the managing entity, it should be known that the same information may be analyzed in the other direction, where the managing entity has received a request to transfer resources (e.g., funds) from an internal account to an external account, so the managing entity system performs a pre-verification of the external receiving account based on the same types of verification factors.

The verification factors for a particular account and/or a user (or group of users associated with the particular account) may comprise non-sensitive information regarding resource distribution timing, account time information, resource distribution amount information, account balance information, general transactional information, location information, transaction device information, account comparison information, account management or maintenance information, user claims information, merchant claims information, and the like.

The verification factors based on resource distribution timing may include a last time that the account was used in a transaction or other resource distribution requests, a frequency of use of the account in executing transactions or other resource distribution requests, a most common or most frequent time of the day (e.g., a specific time of day, a period of time during a given day, or the like) that the account is accessed and/or used by a known user, a most common time period (e.g., time period of a day, week, month, year, or the like) when transactions within a particular price range are conducted, and/or a most common time period (e.g., time period of a day, week, month, year, or the like) when transaction of a particular category (e.g., purchases of a category of product or service, categories of transaction techniques, made with a particular device or type of device, or the like) are conducted.

The verification factors based on account time information may include a length of time that a given account has been open, a length of time that a given account has been active, a length of time since a last transaction made with the particular account, or the like.

The verification factors based on resource distribution amount information may include a range of amounts associated with transactions conducted with a particular account (e.g., a range of a standard deviation, or based on a standard deviation, of transaction amounts transferred out by the account), most common or frequent transaction amounts made (or received) by the particular account, or the like. Of course, in embodiments where the verification factors do not include sensitive information, the use of ranges (e.g., standard deviations) of transaction amounts made by a particular account is a technique for obtaining valuable information about the account and whether a current transaction being made by that account meets the expected transaction amount range, without the managing entity receiving the actual transaction data of the user or knowing actual transaction amounts or other sensitive or personal information.

Similarly, the verification factors based on account balance information may comprise a range (e.g., a standard deviation over a previous month, set of months, year, decade, or other period of time) associated with expected account balance information for the particular account of the user without providing the actual account balance information. Again, while this information does not include sensitive account balance information, it provides enough visibility to the managing entity system to allow the managing entity system to determine a likelihood that the account of the user is able to transfer the requested amount of resources without requesting or requiring the distributed amount of resources to be returned.

The non-sensitive verification factors may further include general transaction information (e.g., information derived from the actual transaction information, trends in transaction information, and the like) which gives the managing entity insight into how the account is typically managed or utilized by the user (and therefore make a determination regarding the verification of the user as the owner or operator of the account), without the communication of additional sensitive information. For example, the verification factors may include general information about major transactions (e.g., types of purchases over a particular transaction amount), common types or categories of transactions (e.g., types of merchants, common amounts transacted with each type of common merchant, and the like), and the like.

The verification factors based on location information may include most common general locations of resource distribution requests (e.g., geographic regions from which the user commonly or most frequently requests or executes transactions), most common general locations of merchants that receive transactions from the particular account, and the like.

The verification factors based on transaction device information may include known devices from which the account has conducted transactions in the past (e.g., specific ATMs, electronic kiosks, mobile devices, or other computing devices). Of course, this information may be filtered to only include transaction device types that are commonly used to request and/or execute transactions or other resource distributions (e.g., ATMs, mobile devices, personal computing devices, mobile computing devices, wearable devices, financial institution branch devices, or the like). This information may further include applications (e.g., third party payment applications on mobile devices or other computing devices) that are most commonly used to request and/or execute transactions using the particular account.

While these verification factors for an individual account (and the particular user's common actions with respect to the individual account) are helpful in determining whether an individual currently requesting a resource distribution from that account is behaving in a manner that is typical of the account owner, information about other accounts of the user that are external to the managing entity system can provide further insight into this determination. For example, if the user has multiple accounts at the first entity, all of which are external to the managing entity system, the verification factors may include account comparison information about which of the multiple accounts the user typically uses to make transactions of a particular type, of a particular amount, at a particular location, with a particular merchant, at a particular time of day, with a particular type of transaction device, and/or the like. In some embodiments, the multiple accounts may comprise accounts managed by another entity (i.e., not the first entity or the managing entity), where this other entity additionally provides verification factors associated with the user in a clearing house database or other shared database that is accessible based on a reference code or the user's name or account information. In this way, the managing entity system is able to leverage the general (i.e., non-sensitive information) knowledge across multiple entities (including itself) to make determinations regarding the verification of an individual as the owner or operator of a particular account.

Furthermore, the verification factors may include information about the habits of the user with respect to other, similar accounts. For example, if the first account described with respect to block 502 is a credit card account, verification factors comprising habits of the user in managing other credit card accounts that are external to the managing entity may provide information regarding how likely or often the account will be paid off in full, a most common range (e.g., a standard deviation over a prior term) of a percentage of credit in use at any given time, or the like.

In some embodiments, the verification factors may include a number and/or frequency of claims or requests for refunds on previously executed transactions or other resource distributions have been made by the user and/or against the user or account. This information is useful in determining a likelihood that a currently-requested resource distribution will subsequently be contested, recalled, reported, or the like.

The system executing this process 500, shall be referred to herein as the managing entity, but it should be known that the managing entity may comprise a financial institution that manages the account that is to receive resources (e.g., funds) as part of the resource distribution request, and/or a clearing house system that facilitates resource distribution requests, verification determinations for individuals and their accounts, authentication of users, facilitates messaging components of the real-time resource processing network, manages a shared database system (e.g., a clearing house database system), and the like.

The received resource distribution request may originate from a computing device of the user, where the user has submitted the resource distribution request, instructing the first entity system to transfer or otherwise distribute a resource amount (e.g., an amount of funds) from the first account and any other message(s) to a second user (i.e., to an account of the second user that is held at a receiving entity that may also be the managing entity). When the user submits the resource distribution request via the first entity system (e.g., via an online portal of the first entity system, via a mobile application of the first entity system, or the like), the first entity system may automatically process the request to comprise a message that is transferrable via the real-time resource processing network, and to include verification factors (or reference numbers or other reference indicia) for the user and/or the first account. As such, the first entity system may identify the user, access a database of verification factors for the user base of the first entity, and match the identification of the user to stored verification factors of the user. The first entity system can then copy or otherwise extract the verification factors from the database of verification factors and add them to the message (e.g., at the end of the message, in a particular data field of the message, in particular data fields of the message, in a subsequent message transmitted in real-time, or the like).

Additionally or alternatively, the first entity system may determine or generate a reference number and/or other verification factor indicia (e.g., a code, a scannable code, an image, a password, a passcode, a database index position, a public key for a particular blockchain network, and the like), along with a reference as to where to access a supplemental database (e.g., a clearing house database, a shared database, a blockchain network, or the like) to access the verification factors for the user and/or the first account by presenting the reference number and/or the other verification factor indicia. In still other embodiments, the identification of the user and/or the first account (e.g., the user name and/or an account number for the first account) may represent verification factor indicia that the managing entity system can later use to access the verification factors for the user and/or the first account.

In some embodiments, the verification factors may comprise one or more large data files or require a considerable amount of processing power or resources to transfer the entirety of the resource factors as part of the resource distribution request. In such embodiments, the user and/or the first entity system that receives the resource distribution request may compress the verification factor data prior to putting it in a message, store the verification factor data in a local or managed database such that the verification factor information is identifiable and/or accessible upon the receipt of a reference code, database index position, keyword search, or the like.

A secure messaging network (i.e., the real-time resource processing network) may be established, managed, or otherwise be a component of a clearing house system and/or the managing entity system. In some embodiments, this secure messaging network is managed or otherwise controlled by one or more entities (e.g., a consortium of financial institutions) like the first entity and the second entity. The secure messaging network may be configured to receive, transmit, display, record, facilitate, or otherwise transfer messages, data, information, content, files, or other media between two or more entity systems.

The clearing house system, and/or the real-time resource processing system (when managed by the managing entity and/or a consortium of entities) is configured to debit a transferring account and credit a receiving account for a resource distribution request in response to determining that the users are verified users for each account, that the transferring user is authenticated, and that the transferring account has enough funds for the transfer.

As described herein, the clearing house database may be a secure database controlled solely by the clearing house system. In other embodiments, at least a portion of the clearing house database is accessible to the first entity system and/or the managing entity system, but not to the user or an owner of the second account. In some embodiments, the clearing house database comprises a blockchain network that is accessible by the first entity system, the clearing house system, or any managing entity system. In such embodiments, a reference to verification factor information stored in the clearing house database may comprise a public key associated with the verification factor information and/or the location of the verification factor information.

In some embodiments, the process 500 includes block 504, where the system extracts verification factors from the message, where the verification factors are associated with the first account and/or the user. In embodiments where the message includes one or more data fields that comprise the verification factors, extracting the verification factors from the message comprises extracting (e.g., copying, removing, scanning, or otherwise obtaining) the verification factor information directly from the message (e.g., from the data fields). However, as noted above, the message may have additionally or alternatively stored at least a portion of the verification factors in a shared database or blockchain network and included a reference number, a passcode, a database index position, or any other indicia (the “reference number”), in the message. In such embodiments, the system may automatically identify the reference number (or any other indicia), and extract the reference number from the message for further processing.

In some embodiments, the step of further processing the reference number comprises transmitting the reference number and a request for the verification factors to the first entity system in real time (e.g., before the resource distribution request is approved, and while the user is still accessing a portal for the transaction, still at an ATM for the transaction, still at a financial institution location for the transaction, or the like). This request may also be in the form of a message via the real-time resource processing network described with respect to FIG. 1B. The managing entity system may then receive, via a message in the real-time resource processing network, the verification factors associated with the user and/or the first account from the first entity system.

Alternatively, upon identifying and extracting the reference number associated with the verification factors from the message, the managing entity system may transmit the reference number and a request for the verification factors to a clearing house database system or other shared database system (e.g., a database accessible to and managed by a consortium of financial institutions, a blockchain network, or the like). The clearing house database system or other shared database system would then identify and extract (e.g., copy) the verification factors for the user and/or the first account based on the received reference number, and transmit the verification factors back to the managing entity system in real-time.

In embodiments where the reference number comprises a clearing house database (or other shared database) index position (e.g., a file location), the system may extract the clearing house database index position from the message, access the clearing house database system, and identify and extract the verification factors at the index position within the clearing house database.

Additionally, in some embodiments, the process 500 includes block 506, where the system determines a verification value for the user based on the extracted verification factors. The verification value for the user represents a quantitative estimation or prediction of the likelihood that the purported user is in fact the owner or permitted operator of the first account. Because the verification value for the user is based on the extracted verification factors of the user and/or the first account, the verification value is representative of how well the current resource distribution request matches, falls in line with, or otherwise corresponds with historical trends, patterns, unique characteristics, and other defining aspects of how the first account has been operated in the past.

Therefore, the system may determine the verification value for the user by generating a statistical model of the verification factors, and comparing features (e.g., resource distribution amount, time of resource distribution request, location of request, transaction device transmitting the request, merchant category associated with the request, account type information, and the like) of the currently pending resource distribution request against the statistical model of the verification factors to determine a degree of matching or similarity. The degree of matching or similarity is quantified as the verification value for the user.

The process 500 may also include block 508, where the system determines whether the verification value for the user is above a predetermined threshold value. The predetermined threshold value may be established or set by a specialist of the managing entity system, or may be established based on a predictive model of historical resource factor data for a plurality of users (e.g., a plurality of users with similar account characteristics to the user, similar age characteristics to the user, similar geographical location to the user, all other users, or the like). As such, the predetermined threshold value represents a minimum confidence level for the managing entity in considering the user to be the verified owner or operator of the first account.

In response to determining that the verification value for the user is above the predetermined threshold value, the process may include block 510, where the system automatically verifies the user for the resource distribution request. When the verification value for the user is above the predetermined threshold value, the system has determined, at least to a minimum confidence level, that the user likely is the verified owner or operator of the first account, and therefore will verify the user for the resource distribution request in real-time. By pre-verifying the user before the resource distribution request is approved or executed, the system is able to make a real-time determination as to whether the resource distribution requester is appropriate, and whether the transaction itself is appropriate.

Alternatively, in response to determining that the verification value for the user is not above the predetermined threshold value, the process may include block 512, where the system automatically terminates the resource distribution request. When the verification value for the user is not above the predetermined threshold value, the system has determined that the user is not likely to be verified as the appropriate owner or operator of the first account and therefore will refuse the resource distribution request. By terminating the resource distribution request in real-time based on the pre-verification check, the system can prevent unauthorized or improper resource distributions in real-time, before the transactions actually occur.

While not shown in FIG. 5, it should be known that the step of determining whether the verification value for the use is above a predetermined threshold value may comprise a step of determining that the verification value for the user is not above the predetermined threshold value, but also determining that the verification value for the user would be adjusted to be above the predetermined threshold value if the user provided stepped-up authentication credentials. In response to making this determination, the system may automatically transmit a request for a user input of the stepped-up authentication credentials to a computing device associated with the user in real-time. If the system receives incorrect stepped-up authentication credentials, or no stepped-up authentication credentials are provided, then the system does not adjust the verification value of the user, and the verification value of the user remains as not being above the predetermined threshold value. However, if the system does receive the user input of the correct stepped-up authentication credentials from the computing device associated with the user, then the system can make a final determination that the verification value for the user is above the predetermined threshold value.

Likewise, while not shown in FIG. 5, it should be known that the system may determine that the verification value for the user is above the predetermined threshold value, but not above a secondary predetermined threshold value. While the predetermined threshold value may be a value for which the managing entity is generally comfortable with or confident in its determination that the user is verified as the owner of the first account, the secondary predetermined threshold value may be associated with a higher level of confidence that the determined user is verified as the owner of the first account. Therefore, if the verification value for the user is between these two thresholds, the system may execute some additional steps in an attempt to mitigate potential exposure to improper or undesired transfers of resources through the resource distribution request. As such, the system may transmit a notification to a computing device associated with the user, where the notification comprises a request for a user input of (i) a confirmation that the resource distribution request is intended by the user, and (ii) an agreement (e.g., a checkbox associated with a statement, a contract, a notice, or the like) that a resource recovery amount for the pending resource distribution request is limited to a particular amount (e.g., a percentage of the total request, no recovery amount is available, a numerical value, or the like). In such embodiments, the step of automatically verifying the user for the resource distribution request is additionally conducted in response to receiving the (i) confirmation that the resource distribution request is intended, and (ii) the agreement that the resource recovery amount for the resource distribution request is limited to the particular amount.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for providing leveraged collaborative pre-verification and authentication for secure real-time resource distribution associated with a managing entity, the system comprising:
a memory device; and
a processing device operatively coupled to the memory device, wherein the processing device is configured to execute computer-readable program code to:
receive, from a first entity system, a message from a user comprising at least a resource distribution request from a first account that is external to the managing entity to a second account that is internal to the managing entity;
extract verification factors from the message associated with the first account or the user;
determine a verification value for the user based on the extracted verification factors;
determine whether the verification value for the user is above a predetermined threshold value; and
in response to determining that the verification value for the user is above the predetermined threshold value, automatically verify the user for the resource distribution request; or
in response to determining that the verification value for the user is not above the predetermined threshold value, automatically terminate the resource distribution request.

2. The system of claim 1, wherein the message comprises the verification factors, and wherein extracting the verification factors from the message comprises extracting the verification factors directly from the message.

3. The system of claim 1, wherein the message comprises a reference number associated with the verification factors.

4. The system of claim 3, wherein extracting the verification factors comprises:
extracting the reference number from the message;
transmitting the reference number and a request for the verification factors to the first entity system; and
receiving the verification factors from the first entity system.

5. The system of claim 3, wherein extracting the verification factors comprises:
extracting the reference number from the message;
transmitting the reference number and a request for the verification factors to a clearing house database system; and
receiving the verification factors from the clearing house database system.

6. The system of claim 1, wherein the message comprises a clearing house database index position associated with the verification factors; and wherein extracting the verification factors comprises:
extracting the clearing house database index position associated with the verification factors; and
identifying the verification factors in the clearing house database at the clearing house database index position.

7. The system of claim 1, wherein the verification factors comprise one or more of a group of: a last time the first account was utilized in a transaction, a frequency of transaction utilization for the first account, a most frequent period of time during a day for the first account to be accessed or utilized, a most frequent period of time during a month when transactions of a particular category are made with the first account, a length of time that the first account has been open or active, a range of most common resource amounts associated with resource distributions from the first account, a set of most common product categories associated with the first account in an amount range associated with the resource distribution request, a set of most common merchants or merchant types associated with resource distributions from the first account, most commonly used transaction devices or transaction device types associated with resource distributions from the first account, a geographic area from which resource distributions from the first account are most commonly requested, additional account information associated with accounts of the user that are external to the managing entity and distinct from the first account, and a total number or frequency of requests to restore resources from previous resource distribution requests from the first account.

8. The system of claim 1, wherein determining whether the verification value for the user is above the predetermined threshold value comprises:
determining that the verification value for the user is not above the predetermined threshold value;
determining that the verification value for the user would be above the predetermined threshold if the user provided stepped-up authentication credentials;
in response to determining that the verification value for the user is not above the predetermined threshold, and in response to determining that the verification value for the user would be above the predetermined threshold if the user provided stepped-up authentication credentials, automatically transmitting a request for a user input of the stepped-up authentication credentials to a computing device associated with the user in real-time; and
determining that the verification value for the user is not above the predetermined threshold value in response to not receiving the user input of the stepped-up authentication credentials; or
determining that the verification value for the user is above the predetermined threshold value in response to receiving the user input of the stepped-up authentication credentials via the computing device associated with the user.

9. The system of claim 1, wherein the processing device is further configured to execute computer-readable program code to:
determine that the verification value for the user is above the predetermined threshold value, but not above a secondary predetermined threshold value; and
in response to determining that the verification value for the user is not above the secondary predetermined threshold value, transmit a notification to a computing device associated with the user, wherein the notification comprises a request for a user input of (i) a confirmation that the resource distribution request is intended, and (ii) an agreement that a resource recovery amount for the resource distribution request is limited to a first amount;
wherein automatically verifying the user for the resource distribution request is additionally conducted in response to receiving the user input of (i) the confirmation that the resource distribution request is intended, and (ii) the agreement that the resource recovery amount for the resource distribution request is limited to the first amount.

10. A computer program product for providing leveraged collaborative pre-verification and authentication for secure real-time resource distribution associated with a managing entity, the computer program product comprising at least one non-transitory computer readable medium comprising computer readable instructions, the instructions comprising instructions for:
receiving, from a first entity system, a message from a user comprising at least a resource distribution request from a first account that is external to the managing entity to a second account that is internal to the managing entity;
extracting verification factors from the message associated with the first account or the user;
determining a verification value for the user based on the extracted verification factors;
determining whether the verification value for the user is above a predetermined threshold value; and
in response to determining that the verification value for the user is above the predetermined threshold value, automatically verifying the user for the resource distribution request; or
in response to determining that the verification value for the user is not above the predetermined threshold value, automatically terminating the resource distribution request.

11. The computer program product of claim 10, wherein the message comprises the verification factors, and wherein extracting the verification factors from the message comprises extracting the verification factors directly from the message.

12. The computer program product of claim 10, wherein the message comprises a reference number associated with the verification factors.

13. The computer program product of claim 12, wherein extracting the verification factors comprises:
extracting the reference number from the message;
transmitting the reference number and a request for the verification factors to the first entity system; and
receiving the verification factors from the first entity system.

14. The computer program product of claim 12, wherein extracting the verification factors comprises:
extracting the reference number from the message;
transmitting the reference number and a request for the verification factors to a clearing house database system; and
receiving the verification factors from the clearing house database system.

15. The computer program product of claim 1, wherein the message comprises a clearing house database index position associated with the verification factors; and wherein extracting the verification factors comprises:
extracting the clearing house database index position associated with the verification factors; and
identifying the verification factors in the clearing house database at the clearing house database index position.

16. The computer program product of claim 1, wherein the verification factors comprise one or more of a group of: a last time the first account was utilized in a transaction, a frequency of transaction utilization for the first account, a most frequent period of time during a day for the first account to be accessed or utilized, a most frequent period of time during a month when transactions of a particular category are made with the first account, a length of time that the first account has been open or active, a range of most common resource amounts associated with resource distributions from the first account, a set of most common product categories associated with the first account in an amount range associated with the resource distribution request, a set of most common merchants or merchant types associated with resource distributions from the first account, most commonly used transaction devices or transaction device types associated with resource distributions from the first account, a geographic area from which resource distributions from the first account are most commonly requested, additional account information associated with accounts of the user that are external to the managing entity and distinct from the first account, and a total number or frequency of requests to restore resources from previous resource distribution requests from the first account.

17. The computer program product of claim 1, wherein determining whether the verification value for the user is above the predetermined threshold value comprises:
determining that the verification value for the user is not above the predetermined threshold value;
determining that the verification value for the user would be above the predetermined threshold if the user provided stepped-up authentication credentials;
in response to determining that the verification value for the user is not above the predetermined threshold, and in response to determining that the verification value for the user would be above the predetermined threshold if the user provided stepped-up authentication credentials, automatically transmitting a request for a user input of the stepped-up authentication credentials to a computing device associated with the user in real-time; and
determining that the verification value for the user is not above the predetermined threshold value in response to not receiving the user input of the stepped-up authentication credentials; or
determining that the verification value for the user is above the predetermined threshold value in response to receiving the user input of the stepped-up authentication credentials via the computing device associated with the user.

18. The computer program product of claim 1, wherein the computer readable instructions further comprise instructions for:
determining that the verification value for the user is above the predetermined threshold value, but not above a secondary predetermined threshold value; and
in response to determining that the verification value for the user is not above the secondary predetermined threshold value, transmitting a notification to a computing device associated with the user, wherein the notification comprises a request for a user input of (i) a confirmation that the resource distribution request is intended, and (ii) an agreement that a resource recovery amount for the resource distribution request is limited to a first amount;
wherein automatically verifying the user for the resource distribution request is additionally conducted in response to receiving the user input of (i) the confirmation that the resource distribution request is intended, and (ii) the agreement that the resource recovery amount for the resource distribution request is limited to the first amount.

19. A computer implemented method for providing leveraged collaborative pre-verification and authentication for secure real-time resource distribution associated with a managing entity, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving, from a first entity system, a message from a user comprising at least a resource distribution request from a first account that is external to the managing entity to a second account that is internal to the managing entity;
extracting verification factors from the message associated with the first account or the user;
determining a verification value for the user based on the extracted verification factors;
determining whether the verification value for the user is above a predetermined threshold value; and
in response to determining that the verification value for the user is above the predetermined threshold value, automatically verifying the user for the resource distribution request; or
in response to determining that the verification value for the user is not above the predetermined threshold value, automatically terminating the resource distribution request.

20. The computer implemented method of claim 19, further comprising:
determining that the verification value for the user is above the predetermined threshold value, but not above a secondary predetermined threshold value; and
in response to determining that the verification value for the user is not above the secondary predetermined threshold value, transmitting a notification to a computing device associated with the user, wherein the notification comprises a request for a user input of (i) a confirmation that the resource distribution request is intended, and (ii) an agreement that a resource recovery amount for the resource distribution request is limited to a first amount;
wherein automatically verifying the user for the resource distribution request is additionally conducted in response to receiving the user input of (i) the confirmation that the resource distribution request is intended, and (ii) the agreement that the resource recovery amount for the resource distribution request is limited to the first amount.
